(19) United States
(12) Patent Application Publication
(10) Pub. No.: US 2010/0013591 A1
(43) Pub. Date: Jan. 21, 2010

(54) Protection Device

(76) Inventor: Hiroyuki Koyama, Narita (JP)

Correspondence Address: Tyco Electronics Corporation, 309 Constitution Drive, Mail Stop R34/2A, Menlo Park, CA, 94025, US

(21) Appl. No.: 12/227,335

(22) PCT Filed: May 14, 2007
(86) PCT No.: PCT/JP2007/059854

§ 371 Date: Sep. 14, 2009

(30) Foreign Application Priority Data
May 17, 2006 (JP) 2006-137791

(51) Int. Cl. H01H 71/00

(52) U.S. Cl. 337/14

(57) ABSTRACT

It is provided a new protection device with a large current capacity, which can sense a relatively low abnormal temperature, and further has a simple construction and is not large in size. The protection device comprises (1) a polymer PTC device (18) having metal electrodes (14, 16) on the both main surfaces, and (2) a shape memory alloy lead (20), wherein the shape memory alloy lead is connected to the polymer PTC device by an electrically conductive adhesive (22) containing a thermoplastic resin and an electrically conductive filler.

### FIELD OF THE INVENTION

The present invention relates to a protection device having a PTC device, specifically a protection device having a PTC device with a shape memory alloy lead connected thereto, and a method of manufacturing such a protection device.

### BACKGROUND ART

A polymer PTC device is used as a protection device to prevent the discharge/charge of excessive current and overheating of a battery pack in a mobile electronic apparatus such as a cellular phone. The polymer PTC device comprises a polymer PTC element, composed of an electrically conductive polymer composition containing a polymer and conductive filler dispersed therein, and metal electrodes disposed on both sides of the polymer PTC element, and the device is placed in close contact with the battery pack. The PTC device performs two functions, one of sensing an abnormally elevated temperature caused by a defect in the battery pack or an overheated condition around the battery pack (hereinafter also called “abnormal elevated temperature”. E.g. 80-90° C.) and becoming highly resistant to prevent the flow of current, and another of sensing an excessive flow of current caused by an electrical defect in the circuit of the battery pack and becoming highly resistant to prevent the flow of current. In other words, overheating and/or excessive current of the battery pack causes the polymer PTC device to become highly resistant, substantially cutting off the circuit so as to prevent components constituting the circuit from failing.

The performance/functions of the mobile electronic apparatus are improving from year to year, entailing increased use of current, so that a large permissible current amount, i.e. current capacity, is desired for the protection device such as a polymer PTC device. In the case of current commercially available polymer PTC devices, those with relatively high current capacity can only sense relatively high abnormal elevated temperatures (for example 110° C.) as to sensing the abnormal elevated temperatures. Therefore, the commercially available polymer PTC devices cannot accommodate the need to sense relatively low abnormal elevated temperatures.

Thus, a polymer PTC device that is composed using a polymer having a lower melting point than the melting point of the polymer used in the above polymer PTC device may be considered in order to decrease the abnormal elevated temperature that can be sensed. However, if such a lower melting point polymer is used, the size of the device itself is increased when trying to make a large current capacity polymer PTC device, and such a polymer PTC device is not suitable for use in a mobile electronic apparatus.

Therefore, a protection device that can sense relatively low abnormal elevated temperatures, and further has a large current capacity, and whose size is not large, needs to be provided.

A protection device combining a PTC device and a spring formed of a shape memory alloy has been proposed (see Patent Reference 1 below). In this protection device, a PTC device is retained within a cylindrical metal case to which one of the leads is connected while being pressed by a bias spring, and positioned such that the other lead is abutting against the PTC device. When the equipment in which this protection device is disposed has an abnormal elevated temperature, the shape memory alloy spring disposed around the other lead and in proximity to the PTC device deforms towards its original shape and expands to push and shift the PTC device, thereby pushing back the bias spring, as a result of which the abutment between the PTC device and other lead is released and the circuit is opened. If abnormal current flows through the PTC device, the PTC device rises in temperature and, as in the previous case, the shape memory alloy spring deforms towards its original shape so that the abutment between the PTC device and other lead may be released.

In sensing overheating and/or excessive current, this protection device performs a similar function as the above described polymer PTC device, but the construction of the protection device is very complicated, as two types of springs are placed within the metal case and the PTC device needs to be retained in the movable state. Further, the PTC device and the other lead is in the abutting state but not connected permanently as with soldering, so that arcing may occur between the PTC device and the other lead when there is excessive current flow. There is a problem in that, when arcing occurs and the PTC device and the other lead are contact welded, the device will not function as a protection device.
[Patent Reference 1] Japanese Patent Laid-Open Publication No. 2002-15902

### DISCLOSURE OF THE INVENTION

### [Problem to be Solved by the Invention]

Therefore, the object of the present invention is to provide a new protection device having a large current capacity, which can sense a relatively low abnormal elevated temperature, has a simple construction and is not large in size.

### [Means to Solve the Problem]

As a result of concentrated studies as to the above object, it has been discovered that it is convenient to allocate functions such that a function of sensing a relatively low abnormal elevated temperature and substantially cutting off current flowing through a circuit is assumed by a shape memory alloy lead, and a function of sensing excessive current and substantially cutting off the current flowing through the circuit is assumed by a PTC device when, in a protection device having the polymer PTC device, the PTC device is connected with the shape memory alloy lead (lead made of a shape memory alloy) in series using an electrically conductive adhesive containing a thermoplastic resin wherein the shape memory alloy lead to be used is designed so that the temperature at which it returns to its original memorized shape (so-called shape recovery temperature) is relatively low.

Therefore, in the first aspect, the present invention provides a protection device having:

(1) a polymer PTC device comprising metal electrode(s), and

(2) a shape memory alloy lead,

characterized by the shape memory alloy lead being connected to the polymer PTC device (more specifically its metal electrode) by an electrically conductive adhesive comprising a thermoplastic resin and an electrically conductive filler. It is noted that the shape memory alloy lead may be electrically connected by such conductive adhesive whilst in contact with the metal electrode, or it may be electrically connected with the metal electrode via the electrically conductive adhesive without being in direct contact with the metal electrode.

In the protection device of the present invention, the shape memory alloy lead has been treated such that it will deform towards its original memorized shape above a predetermined abnormal elevated temperature. The original memorized shape is such that one end of the shape memory alloy lead connected to the polymer PTC device (specifically its metal electrode) becomes sufficiently separated from the PTC device (specifically its metal electrode).

In other words, when the temperature of the protection device or its ambient is lower than the predetermined abnormal elevated temperature, the shape memory alloy lead is shaped such that said one end is in contact with the electrode of the PTC device or is positioned in proximity adjacent to the electrode, but when the abnormal elevated temperature is exceeded the predetermined abnormal elevated temperature, the shape memory alloy lead recovers, as a result of which said end of the shape memory lead is sufficiently separated from the electrode of the PTC device. Thus, the PTC device and the shape memory alloy lead are in the state wherein they are not electrically connected.

As such a lead, a shape memory alloy lead treated to have a relatively low recovery temperature may be used. With respect to the recovery temperature of a member made of the shape memory alloy, it is known that various desired recovery temperature may be set by means of the composition of the alloy, processing conditions, the heat treatment temperature, and the like. In fact, it is known that if the desired recovery temperature of the shape memory alloy member is given to the desired manufacturer of the shape memory alloy members, a shape memory alloy member having that recovery temperature may be obtained form the manufacturer. For example, it is known that, for an Ni—Ti based shape memory alloy members, the desired recovery temperature may be set in the range of 10-100° C. In one embodiment, the recovery temperature of the shape memory alloy lead is for example 70° C.-100° C., and preferably 80° C.-90° C.

Any shape memory alloy may be used to form the lead of the protection device of the present invention, as long as a needlessly large resistance is not added to the circuit in which the protection device is placed and the desired recovery temperature may be set on the lead. Specific examples are, in addition to the above, an Ni—Ti alloy, an Ni—Ti—Fe alloy, an Ni—Ti—Cu alloy, and the like. The lead may be of any appropriate form. For example, it may be in the form of a wire, a strip, or a coil.

In order for the shape memory alloy lead to recover as described above, the adhesive function of the electrically conductive adhesive connecting the PTC device and the lead must not obstruct the recovery. The adhesive function of the electrically conductive adhesive is provided by the thermoplastic resin which forms the adhesive, so that the electrically conductive adhesive, in particular its thermoplastic resin, is preferably already in a softened state at or close to the recovery temperature of the shape memory alloy lead to the extent that it does not obstruct the recovery of the shape memory alloy lead. However, if the softening is too soon, this may adversely affect the connection between the PTC device and the lead, so the thermal deformation temperature of the thermoplastic resin is preferably roughly the same as the recovery temperature of the lead, or a little lower (for example 5° C.-10° C. lower than the recovery temperature of the lead). In other embodiment, the thermoplastic resin may soften at a temperature higher than the recovery temperature. In this case, the abnormal elevated temperature is not the recovery temperature of the shape memory alloy lead, but the abnormal elevated temperature that the protection device senses becomes the thermal deformation temperature of the thermoplastic resin.

Specifically, the thermal deformation temperature of the thermoplastic resin is ideally substantially equal to, or at most 15° C. lower than, the recovery temperature of the shape memory alloy lead, and preferably at most 10° C. lower. The thermal deformation temperature of the thermoplastic resin may be higher than the recovery temperature, in which case if the temperature of the thermoplastic resin is higher than the recovery temperature and lower than the thermal deformation temperature, the thermoplastic resin restricts the lead that is trying to recover to its original shape and obstruct its recovery; when it reaches the thermal deformation temperature or above, the lead will substantially recover to its original shape. In considering all these, more specifically, the thermal deformation temperature of the thermoplastic resin is in the range for example of recovery temperature ±15° C., preferably in the range of recovery temperature ±10° C., more preferably recovery temperature −5° C.≦thermal deformation temperature≦recovery temperature +5° C. The most preferred is recovery temperature −5° C.≦thermal deformation temperature. If the recovery temperature of the shape memory alloy lead is 80° C. for example, the thermal deformation temperature of the thermoplastic resin is preferably 70° C.-90° C., and more preferably 75° C.-85° C. The particularly preferable recovery temperature is 75° C.-80° C.

Various types of conductive adhesives containing such a thermoplastic resin are commercially available, so that one may be selected that contains a thermoplastic resin having an appropriate thermal deformation temperature. For example, one containing an acrylic resin, polyester resin, polyolefin resins, and the like as binder with an electrically conductive filler (for example a metal filler such as silver (Ag) filler, nickel (Ni) filler, copper (Cu) filler and the like) may be used as the electrically conductive adhesive. For example, Dotite D-500, D-362, and the like, manufactured by Fujikura Chemical may be used. Such an electrically conductive adhesive is commercially available in the state in which the thermoplastic resin is dissolved or dispersed (or partly dissolved and partly dispersed) in an appropriate solvent (for example, an organic solvent such as a thinner, an S-thinner, toluene and the like). In order that the shape memory alloy lead is connected to the PTC device by means of such electrically conductive adhesive, the adhesive is applied onto the PTC device, and the solvent is evaporated (if necessary, with heating) while the lead is kept in the state of being inserted into a layer of the adhesive (and further being in contact with the metal electrode of the PTC device if necessary). Thus, the protection device of the present invention does not substantially include the solvent contained in the electrically conductive adhesive.

In this specification, it is noted that the term of the recovery temperature of the shape memory alloy lead is used in the sense generally used in the field of shape memory alloys, and means the temperature at which, when it is reached, the shape memory alloy lead tries to return to its memorized original shape. Further, the thermal deformation temperature means the temperature measured in accordance with JIS K7191.

Since, in the protection device of the present invention, the shape memory alloy lead has the function of sensing the abnormal temperature elevation, an appropriate PTC device may be selected for the PTC device, based on the capacity of the PTC device while considering the requirements of the electronic/electrical apparatus in which the protection device is used. In other words, a desired PTC device with a prescribed capacity may be used in the protection device of the present invention without considering restrictions related to the abnormal temperature elevation sensing function. The polymer PTC device comprises, as is well known, a polymer PTC element composed of a polymer and an electrically conductive filler dispersed therein, and metal electrode(s) provided on the main surface(s) (usually the two main surfaces) of the element. As such polymer PTC device, any appropriate known one in the public domain may be selected, and it will normally have metal electrodes (preferably metal foil electrodes) on the main surfaces of the both sides of the polymer PTC element.

A polymer PTC device that is particularly preferred for use in the protection device of the present invention is one with a large capacity notwithstanding a small size. For example the holding current capacity of the polymer PTC device is preferably at least 1.6 A at 70° C., and more preferably at least 2.0 A at 70° C. In such a protection device of the present invention, there is no need to consider the abnormal elevated temperature that can be sensed. Specifically, a PTC device may preferably be used having a PTC element using a polyethylene, a polyvinylidene fluoride (PVDF) or the like as the polymer constituting the PTC element, and an Ni filler, an Ni alloy filler (for example an Ni—Co filler), carbon black filler and the like as the electrically conductive filler constituting the PTC element. In particular, a PTC device using an Ni alloy filler is preferred. In the protection device of the present invention, the trip temperature of the polymer PTC device is not particularly restricted, but is preferably higher than the recovery temperature of the shape memory alloy lead or the thermal deformation temperature of the thermoplastic resin (if this is higher than the recovery temperature). For example, it is preferably at least 20° C. higher, and more preferably at least 40° C. higher.

In the second aspect, the present invention provides a method of manufacturing a protection device comprising a polymer PTC device. This method is characterized by connecting a shape memory alloy lead to at least one of metal electrode of a polymer PTC device using an electrically conductive adhesive containing a thermoplastic resin. The protection device of the present invention as described above and below may be manufactured through such a method. Also, the present invention provides a protection circuit having the protection device of the present invention as described above and below, and further an electrical/electronic apparatus (for example, an OA equipment such as a personal computer, a printer and the like, an electric components such as a transformer, a solenoid and the like, a battery or a battery pack such as a lithium ion battery, a nickel hydride battery and the like, a charger, a temperature fuse and the like for such battery or battery pack) having such a protection circuit.

### [Effect of the Invention]

With the protection device of the present invention, as a result of the shape memory alloy lead assuming the function of sensing an abnormal elevated temperature, the degree of freedom in selecting the polymer PTC device having the function of sensing abnormal current is increased. As a result, a polymer PTC device having a large capacity may be used so that a protection device that is small in size and wherein the abnormal elevated temperature that is sensed is low. Further, the construction of this protection device is very simple as it only has the shape memory alloy lead and the polymer PTC device connected by an electrically conductive adhesive.

### BRIEF DESCRIPTION OF THE DRAWINGS

[FIG. 1]

FIG. 1 shows a schematic side view of a protection device of the present invention inserted in a protection circuit of an electronic apparatus (only a portion of the protection circuit is shown), FIG. 1(a) shows a state wherein the electronic apparatus is in a normal state, and FIG. 1(b) shows a state wherein the electronic apparatus reaches an abnormal elevated temperature, with the protection circuit sensing this and opening the circuit.

[FIG. 2]

FIG. 2 shows a schematic side view of a protection device of the present invention disposed on a wiring substrate (only a portion of the protection circuit is shown), FIG. 2(a) shows a state wherein the wiring substrate is in a normal state, and FIG. 2(b) shows a state wherein the wiring substrate reaches an abnormal elevated temperature, with the protection circuit sensing this and opening the circuit.

### EXPLANATION OF THE LEGENDS

10—protection device; 12—PTC element; 14, 16—metal electrode; 18—PTC device; 20—shape memory alloy lead; 22—electrically conductive adhesive; 24—insulation material; 26, 28—lead; 30—solder; 40—wiring substrate; 42, 44—electrically electrode; 46—conductive adhesive.

### BEST EMBODIMENT TO CARRY OUT THE INVENTION

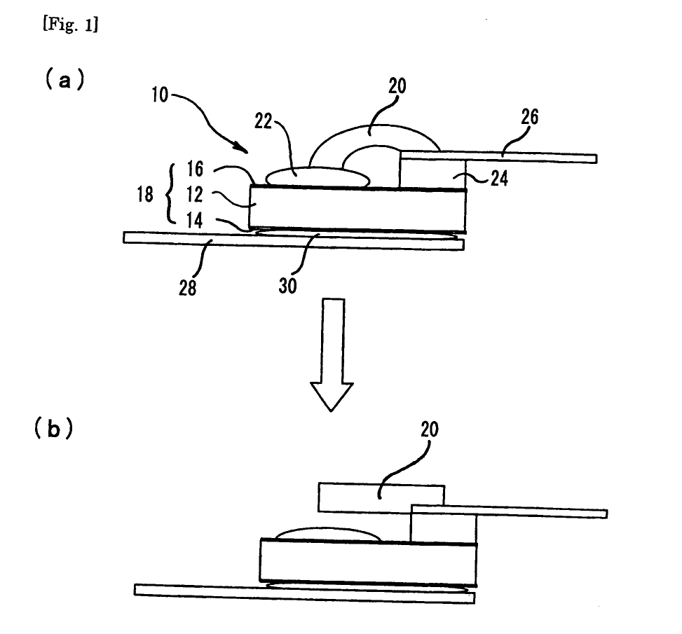

Next, the protection device of the present invention will be explained in more detail with reference to the attached drawings. FIG. 1(a) shows a schematic side view of the protection device of the present invention inserted in a protection circuit of an electronic apparatus (only a portion of the protection device is illustrated). In the illustrated embodiment, the protection device 10 of the present invention comprises a polymer PTC device 18 comprising a polymer PTC element 12 composed of an electrically conductive polymer composition, and metal electrodes 14 and 16 disposed on both sides of the element, and a shape memory alloy lead 20 connected to the PTC device.

In the illustrated embodiment, the lead 20 is in the form of a short bent strip; one end of the lead 20 is connected via an electrically conductive adhesive 22 containing a thermoplastic resin to a polymer PTC device 18, in particular to the metal electrode 16 thereof.

In the illustrated embodiment, an insulating material 24 is placed on the metal electrode 16 of the PTC device and a lead 26 is disposed thereon. The other end of the shape memory alloy lead is connected to the lead 26 by an appropriate method. For example solder, an electrically conductive adhesive (in particular a thermosetting type) or the like may be used.

Also, the lower metal electrode 14 of the PTC device 18 is connected to another lead 28. In the illustrated embodiment, it is connected electrically by solder, for example. In the illustrated embodiment, each of the leads 26 and 28 are respectively connected to a predetermined electrical element or an electric wiring, and the protection device 10 forms a prescribed protection circuit in an electronic apparatus.

As a result, if the temperature of the protection device 10 or its ambient reaches a predetermined abnormal elevated temperature, the electrically conductive adhesive (in particular, the thermoplastic resin contained therein) 22 softens, while at the same time or afterwards the shape memory alloy lead 20 recovers towards its original shape. Such a recovered state is shown in FIG. 1(b). In the illustrated embodiment, the bent lead 20 has recovered to a shape that is substantially flat, as a result of which one end of the shape memory alloy lead 20 is sufficiently separated from the PTC device with a space in between. In other words, the circuit is in an opened state and electrically cut off.

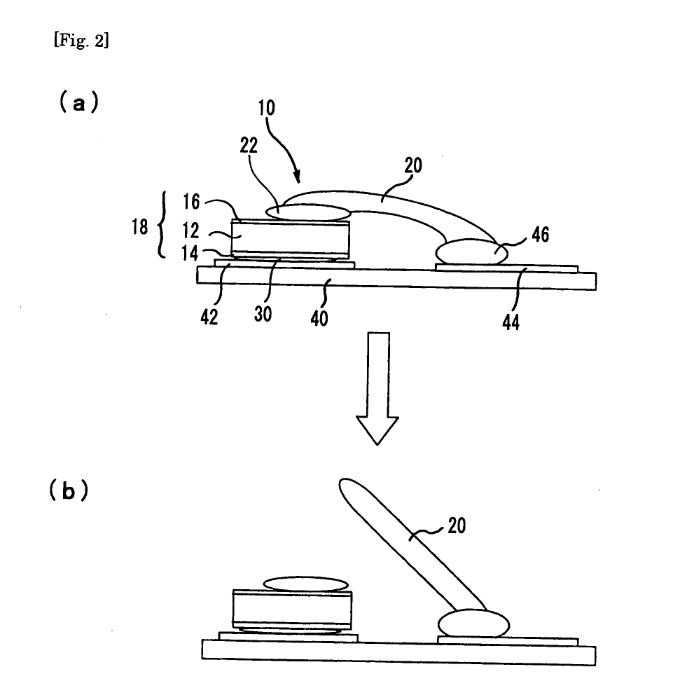

In the embodiment illustrated in FIG. 1, the shape memory alloy 20 is in a strip form, but the lead 20 may be of any appropriate shape. For example, it may be of a wire form. Such a protection device is shown schematically, as in FIG. 1, in FIG. 2. In FIG. 2(a), the protection device 10 of the present invention is electrically connected between the electrode (or lead) 42 provided on a wiring substrate 40 and another electrode (or lead) 44 to form a protection circuit.

As in FIG. 1, the protection device 10 comprises a polymer PTC device 18 comprising a polymer PTC element 12 composed of an electrically conductive polymer composition, and metal electrodes 14 and 16 disposed on both sides thereof, and a shape memory alloy lead 20 connected to the PTC device.

In the illustrated embodiment, the lead 20 is in the form of a bent and short wire. One end of the lead 20 is connected electrically to the polymer PTC device 18, in particular its metal electrode 16, via an electrically conductive adhesive 22 containing a thermoplastic resin. The other end of the shape memory alloy lead is connected electrically to an electrode (or lead) 44 by an appropriate method (for example, by soldering or conductive adhesive 46). It is noted that the lower electrode 14 of the PTC device is connected to an electrode 42 provided on a wiring substrate 40. In the illustrated embodiment, it is connected electrically by solder 30, for example.

Also in the case of FIG. 2, if the temperature of the wiring substrate, the protection device or its ambient reaches a predetermined abnormal elevated temperature, the electrically conductive adhesive 22 softens, while at the same time or afterwards the shape memory alloy lead 20 recovers towards its original shape. Such a recovered state is shown in FIG. 2(b). In the illustrated embodiment, the bent lead 20 has recovered to a shape that is substantially linear, as a result of which one end of the shape memory alloy lead 20 is sufficiently separated from the PTC device with a space in between. In other words, the circuit is in an opened state and electrically cut off.

In another embodiment, which is not illustrated, the shape memory alloy lead may, for example, be in a coiled form. The protection device may be designed such that, from a state wherein the coil is extended and connected to the metal electrode of the PTC device, the coil recovers to a shrunk state, thereby separating from the metal electrode.

It is noted that, in the illustrated embodiment, the protection device 10 of the present invention forms a protection circuit by connecting the leads 26 and 28 or the electrodes 42 and 44; these leads or electrodes may be of any appropriate element as long as they are electrical elements for connecting to the protection device so as to form a protection circuit, and are not particularly restricted. The leads or electrodes may, for example, be electrical elements constituting parts of the wiring substrate, for example they may be pads, lands, wiring, and the like.

### EXAMPLE

### Example 1

### Manufacturing of Protection Device

Using the elements below, the protection device of the present invention was connected to a wiring substrate, as shown in FIG. 2(a) (however, only the shape of the shape memory alloy lead is different, as described below):

(1) Polymer PTC Device (manufactured by Tyco Electronics Raychem K.K.)
Product name: PolySwitch (holding current capacity: 2.0 A (at 70° C.), trip temperature: 125° C.)
Size: 3.4 mm×3.6 mm (thickness 0.5 mm)
Polymer PTC element (polyethylene+nickel filler)
Metal electrode: gold-plated nickel (thickness: 0.03 μm)
   (2) Shape memory alloy lead (manufactured by K.K. Furukawa Techno Material, Ni—Ti—Cu)
Product name: NT Alloy
Size: OD 0.75 mm×approx. 10 mm
Shape: Linear wire shape before recovery->bent wire shape after recovery
Recovery temperature: 80° C.
   (3) Conductive adhesive (manufactured by Fujikura Chemical)
Product name: Dotite D-500
Thermoplastic resin: acrylic resin (thermal deformation temperature: 70-80° C.)
Conductive filler: silver filler

The polymer PTC device 18 was connected with solder 30 to the electrode 42 placed on a glass epoxy wiring substrate 40. Next, one end the linear shape memory alloy lead 20 is connected with the electrically conductive adhesive 46 to another lead 44 placed on said glass epoxy wiring substrate.

The electrically conductive adhesive 22 is then coated on the exposed metal electrode 16 of the polymer PTC device, and the shape memory alloy lead 20 is connected to the polymer PTC device 18, while maintaining the other end of the shape memory alloy lead 20 in contact with the metal electrode 16, by vaporizing the solvent contained in the electrically conductive adhesive, thus placing the protection device of the present invention on the glass epoxy wiring substrate.

### Example 2

### Confirmation of Action of Protection Device

When current at 20 A/6V was applied at 25° C. to the substrate provided with the protection device as described above, the polymer PTC device 18 tripped, after which the shape memory alloy lead was actuated by the heat generated by the polymer PTC device, and the current flowing through the circuit was substantially cut off.

When current at 100 mA/6V (the PTC device never trips under this conditions) was passed through another substrate provided with the protection device as described above and the temperature around the substrate raised gradually from 50° C.; so that the ambient temperature reached 80° C., the circuit in which the protection device was inserted was opened as the linear shape memory alloy lead recovered and became bent, thus separating from the electrically conductive adhesive 22 (see FIG. 2(b); it is noted that the shape of the lead 20 is bent).

### INDUSTRIAL APPLICABILITY

Since the sensing of the abnormal elevated temperatures is entrusted to the shape memory alloy lead in the protection device of the present invention, the degree of freedom in designing the protection device is increased as the design of the PTC element, which senses abnormal currents and cuts the current off, is not affected by the abnormal elevated temperatures.

The present application claims a priority based on Japanese Patent Application No. 2006-137791 (Filing date: May 17, 2006, Title of the invention: Protection Device). All disclosed in the Application are incorporated herein by reference in their entirety.

1. A protection device comprising:
(1) a polymer PTC device having a metal electrode, and
(2) a shape memory alloy lead having a recovery temperature,
characterized by the shape memory alloy lead being connected to the polymer PTC device by an electrically conductive adhesive comprising a thermoplastic resin and an electrically conductive filler.

2. The protection device according to claim 1, wherein the shape memory alloy lead is made of a Ti—Ni alloy, a Ti—Ni—Cu alloy, or a Ti—Ni—Fe alloy.

3. The protection device according to claim 1, wherein the recovery temperature of the shape memory alloy lead is 70° C.-100° C.

4. The protection device according to claim 1, wherein the thermoplastic resin has a thermal deformation temperature equal to or at most 10° C. lower than the recovery temperature of the shape memory alloy lead.

5. The protection device according to claim 1, wherein the thermoplastic resin contained in the electrically conductive adhesive comprises an acrylic resin.

6. The protection device according to claim 1, wherein the polymer PTC device comprises a polymer PTC element, which contains a Ni filler or Ni alloy filler as a constituent in the polymer PTC element.

7. A method of manufacturing a protection device comprising a polymer PTC device comprising a metal electrode, said method comprising, connecting a shape memory alloy lead to the metal electrode of the polymer PTC device with using an electrically conductive adhesive containing a thermoplastic resin.

8. The method of manufacturing the protection device according to claim 7, wherein the shape memory alloy lead is made of a Ti—Ni alloy, a Ti—Ni—Cu alloy, or a Ti—Ni—Fe alloy.

9. A protection circuit comprising the protection device according to claim 1.

10. (canceled)

11. The method of manufacturing the protection device according to claim 7, wherein the recovery temperature of the shape memory alloy lead is 70° C.-100° C.

12. The method of manufacturing the protection device according to claim 7, wherein the thermoplastic resin a thermal deformation temperature equal to or at most 10° C. lower than the recovery temperature of the shape memory alloy lead.

13. The method of manufacturing the protection device according to claim 7, wherein the thermoplastic resin contained in the electrically conductive adhesive comprises an acrylic resin.

14. The method of manufacturing the protection device according to claim 7, wherein the polymer PTC device comprises a polymer PTC element, which contains a Ni filler or a Ni alloy filler as a constituent in the polymer PTC element.
